(19) United States
(12) Patent Application Publication
(10) Pub. No.: US 2011/0139821 A1
(43) Pub. Date: Jun. 16, 2011

(54) CONNECTOR HAVING MIXING ELEMENT FOR DISCHARGE ARRANGEMENT

(75) Inventors: Andy Greter, Baar (CH); Ralph Egon Kayser, Luzern (CH); Wilhelm A. Keller, Merlischachen (CH)

(73) Assignee: MEDMIX SYSTEMS AG, Rotkreuz (CH)

(21) Appl. No.: 13/059,353

(22) PCT Filed: Sep. 18, 2009
(86) PCT No.: PCT/CH2009/000307

§ 371 Date: Feb. 16, 2011

(30) Foreign Application Priority Data
Sep. 22, 2008 (CH) 01495/08

(51) Int. Cl. B67D 7/74

(52) U.S. Cl. 222/145.5

(57) ABSTRACT

A discharge arrangement for discharging a mixture comprises a connector (6) having at least two inlet channels (7, 7′) ending a mixing channel (8). A static mixing element (10) is provided in the mixing channel. A distal end region of the mixing channel is surrounded by a cone region (13), the outer circumference of which continuously tapers in the direction of the outlet of the mixing channel and which serves as a fastening region for an accessory (23) of the discharge arrangement. The cone region is designed as a luer cone in order to ensure the easy connection of accessories. The mixing element extends into the fastening region in order to minimize the dead volume.

### TECHNICAL FIELD

The present invention relates to a discharge device for discharging a mixture of at least two components, in particular a discharge device with a connector on which accessories for the discharge device are to be fastened.

### PRIOR ART

The prior art discloses numerous discharge devices for discharging mixtures, e.g. from double syringes or double cartridges, in which mixing components are provided in each of the containers of the double syringe and are mixed together by means of the discharge device just shortly before they are used. For example, in the case of medicaments that are unstable in the mixed form, or in the case of mixtures that harden soon after being mixed, it is necessary for mixing to take place just shortly before they are used. Particularly in the field of medical technology, it is in many cases necessary to produce a mixture just shortly before the latter is applied or injected. The mixing components are generally stored in the individual containers of the double syringe or can be sucked into the syringe just before application. A mixer is generally fitted onto the discharge device, said mixer having inlet channels for the respective component from each container of the double syringe, and a mixing channel into which the inlet channels open. Mixing elements in the form of a helix or other mixing means are provided in the mixing channel, such that, when the mixing components are discharged from the double syringe, the components are brought together in the mixing channel and are mixed together homogeneously by the mixing elements.

WO 94/14698, for example, discloses a discharging and mixing apparatus in which a mixer attachment can be fastened over the outlets of the containers of a double cartridge. The mixer attachment has, at one end, fastening wings that engage in fastening grooves on the double cartridge. The mixer attachment further has two inlet channels which, when the mixer attachment is fastened on the double cartridge, adjoin the outlets of the two containers. The inlet channels open into a mixing channel formed by a tube in which mixing elements are arranged. The tube has a cylindrical diameter along the entire length and has four longitudinally extending support struts, which support the tube on the fastening base.

EP 1 825 927 discloses a multi-component syringe with two containers, which each contain a component, and with a mixer outlet. The mixer outlet is designed, as a continuation of the containers, in the form of a tube in which a mixing element is accommodated. The mixing tube opens into the interior of the multi-component syringe in such a way that openings in the tube form an access to a respective container. When the components are discharged from the multi-component syringe, the individual components are thus discharged directly from the container into the mixing tube and are mixed by the mixing elements along the length of the mixing tube.

WO 00/21842 discloses a double syringe on which a mixer can be fastened in a releasable manner. The mixer has a mixing tube, which tapers like a cone as far as an outlet. In the mixing tube, mixing elements in the form of a helix are provided which extend about half way along the interior of the mixing tube. Adjacent to and downstream from the area with the mixing element, the mixture passes through an empty stretch of approximately the same length in the mixing tube, until the tube is tapered to the extent that it is suitable for discharging the mixture. There is no provision for fitting an accessory onto the mixing tube.

In the discharge devices of the prior art for discharging a mixture, the mixer is either an integral part of the discharge device or can be mounted as an independent part on the discharge device. If further accessories are fitted onto the mixer, this lengthens the path along which a mixture has to travel in the discharge device before being discharged, with the result that the loss volume of the mixture remaining in the discharge device increases and the time until the mixture is discharged is prolonged. Both of these factors can have a disadvantageous effect on the mixture. Short dwell times and a small loss volume are, however, of great importance for many substances. In the case of hardening mixtures, the dwell time in the mixer must be shorter than the reaction time of the components, since otherwise the mixer becomes blocked.

### DISCLOSURE OF THE INVENTION

It is therefore an object of the present invention to provide a discharge device having a mixing mechanism, the discharge device being suitable for receiving accessories of the discharge device, without the loss volume being disadvantageously affected or the dwell time of the mixture inside the discharge device being unnecessarily prolonged.

This object is achieved by a discharge device with the features of claim 1. Advantageous embodiments are set forth in the dependent claims.

A discharge device is therefore proposed that has a connector for the attachment of an accessory, with at least a first and a second inlet channel, and with a mixing channel into which the inlet channels open and which ends at an outlet. The discharge device further comprises a static mixing device with a mixing element, which mixing element is arranged in the mixing channel (preferably a helical element based on multiple shearing, e.g. a mixing helix, several mixing helices arranged in succession, or another arrangement of several blades, shearing baffles or projections arranged in succession along the longitudinal direction and serving to mix the components together by a shearing action). The connector has a cone area, which is designed as a fastening area for an accessory and of which the outer circumference tapers continuously in a conical formation along a longitudinal direction as far as the outlet of the mixing channel and which radially surrounds at least a distal end portion of the mixing channel ending at the outlet. At least part of the mixing element is then arranged in the distal end area of the mixing channel surrounded by the cone area, i.e. the mixing element of the mixing device extends into the distal end portion of the mixing channel.

The mixing element thus lies inside the cone area as seen from the radial direction. The distance for discharging a mixture is therefore not lengthened by the fastening area for the accessory, and instead the fastening area lies “alongside” the mixing area with the mixing element in relation to the longitudinal direction. In this way, the dead volume in the connector is reduced. The mixing device and the cone area are preferably arranged concentrically with respect to the longitudinal axis of the cone area.

The mixing element preferably extends along at least 90% of the length, particularly preferably along substantially the entire length, of the distal end portion of the mixing channel surrounded by the cone area, i.e. substantially as far as the outlet of the mixing channel, in order to reduce the dead volume to a minimum.

The cone area is designed as a male Luer cone with an external taper of approximately 6% with respect to the longitudinal direction. Further features of a Luer cone can be gleaned from the relevant standard ISO 594/1-1986 (First Edition, 1986-06-15), to which reference is hereby made and which, in its entirety, is hereby incorporated by reference into the present disclosure. In particular, the length of the cone area is preferably at least 7.5 mm. The diameter at the distal end of the cone area (i.e. at the outlet) is preferably 3.92-4.027 mm, and the diameter at the other end of the cone area is preferably 4.270-4.315 mm. Since the cone area forms a Luer cone, accessories can be fitted on the connector via a standardized connection.

The discharge device can further comprise:
at least two separate or integrally joined containers, each receiving a mixing component, wherein each of the containers has a container outlet, and
a discharge mechanism for discharging the mixing components through the container outlets.

The connector then adjoins the container outlets.

The at least two containers, each receiving a mixing component, can be present, for example, in the form of a double syringe or double cartridge. However, it is also possible to provide two individual syringes, one on each inlet channel of the connector. It is also possible in principle to provide more than two containers. For example, three containers can be provided, which are arranged in a triangle. It is also possible to have more than three containers. The discharge mechanism is provided, for example, by a drive rod, for example a ram or a plunger rod, in each container. The individual drive rods in the respective containers can be connected at their end protruding from the containers, or they can also be connected to each other by a separate connection element. The mixing components are discharged through the container outlets by means of the discharge mechanism being pushed into the containers.

The connector, which adjoins the container outlets, is preferably removable from the outlets. In principle, however, the connector can also be permanently connected to the container outlets. The connector preferably has an opening for each container outlet, into which opening it is possible to insert the container outlet, which is provided, for example, by a tubular extension of the container. However, it is also possible in principle to provide the connector over housing parts of the container housings. The connector can then advantageously be used as a holder for the containers.

The inlet channels of the connector adjoin the openings for receiving the container outlets, such that a mixing component that is discharged through the container outlet is introduced into the inlet channel of the connector. The individual inlet channels of the various containers open into the mixing channel.

The static mixing device in the mixing channel can contain various mixing means or mixing elements, for example helical elements or shearing baffles/shearing blades. The mixing device can also be configured differently, as long as sufficient mixing of the mixing components takes place. Such mixers are known in principle, are easy to produce and are able to mix the components of most mixtures.

According to the present invention, the mixing channel is provided at least partially in a cone area (which can also be designated as cone element), in other words in a frustoconical area/element. The outer circumference of the cone area is greater at the end facing the inlet channels than at an outlet of the mixing channel. Accordingly, the outer circumference tapers in the direction of the outlet of the mixing channel. The taper is continuous along the length of the mixing channel. The mixing channel lying in the interior of the cone area can be tubular or cylindrical. However, it is also possible that the mixing channel also tapers in the direction of the outlet of the mixing channel. The mixing device is adapted to the shape of the mixing channel, such that the space in the mixing channel is filled by the mixing device.

The outer circumference of the cone area serves as a fastening area for an accessory of the discharge device, for example a discharge nozzle, a catheter or an injection needle. Other accessories can also be attached. In order to fasten it on the cone area, the accessory preferably has a tubular or channel-like opening into which the cone area of the connector is pushed or fitted. The opening preferably serves as a discharge channel or opens into a discharge channel for the mixture and extends in the longitudinal direction through the accessory. The diameter of the channel opening of the accessory lies between the greatest and the smallest diameter of the cone area. When the accessory is fitted onto the cone area of the connector, a force-fit connection is obtained for the accessory. The inner circumference of the channel opening of the accessory can have the same conical taper as the outer circumference of the cone element and, in particular, can be designed as a female Luer cone.

In a discharge device according to the present invention for discharging a mixture, an accessory can be provided directly over the mixing area of the discharge device. It is not necessary for the accessory to be fastened in the manner of a serial arrangement on a fastening element following downstream of the mixing area, thus lengthening the overall discharge distance, which would have a disadvantageous effect on the loss volume of the channels and on the dwell time of the mixture in the mixer. According to the present invention, the fastening area for the accessories is advantageously provided radially alongside the mixing area or parallel to the mixing area, with respect to the longitudinal direction. The channel length of the mixing channel can thus be used at the same time for fastening the accessories. The dwell time of the mixture in the channels of the discharge device is thus shortened, without this having a disadvantageous impact on the way the mixing components are mixed.

In one embodiment of the present invention, the connector has an insertion channel, which adjoins the mixing channel in the longitudinal direction and which opens out from the connector in the proximal direction away from the distal end area, i.e. in the direction of the containers. The insertion channel preferably comes to lie parallel to the inlet channels for the container outlets and is arranged between these. In this way, the connector is not unnecessarily lengthened in the longitudinal direction of the discharge device. The mixing device associated with the connector, in particular the mixing element, can be inserted through this channel into the mixing channel. For this purpose, a mixing device with a mixing element or with mixing elements is chosen which, for example, can be designed as an elongate rod which, at least in the area that comes to lie in the mixing channel, has a mixing profile, e.g. in the form of a helix or of projections. The mixing elements can thus have different mixing profiles or elements with different profiles depending on the requirements for the production of a mixture.

In the area of the mixing device that comes to lie in the insertion channel of the connector, the mixing device is preferably cylindrical or slightly conical, such that it fills the volume of the channel. This part of the mixing device also serves as an anti-twist mechanism or for centering or positioning the mixing elements of the mixing device in the connector and thus in the mixing channel. It is designated below as centering cylinder. The anti-twist or positioning mechanism can be provided, for example, by lateral projections on the centering cylinder and grooves in the channel, into which grooves the lateral projections engage. The mixing device can thus be provided in a desired orientation inside the connector or the mixing channel.

A separating wall can be provided between the centering cylinder and the mixing element of the mixing device. When the mixing device is inserted into the connector, the separating wall comes to lie in the area in which the two inlet channels open into the channel for the insertion of the mixing device. The two components delivered from the respective inlet channels are separated from each other by the separating wall, and they come into contact with each other only in the area of the mixing elements in the mixing channel.

In a further embodiment of the present invention, the connector has, on the outer circumference, an annular groove in which a union nut with an internal thread is guided rotatably. The connector with the annular groove and the union nut is preferably designed as a Luer lock connection according to ISO 594-2:1998. An accessory, which is fitted onto the connector, can have a thread on the outer circumference, which thread meshes with the thread of the union nut. In this way, the accessory can be fastened on the cone area not only by a force-fit connection but also by a screwed connection.

In this embodiment too, both the force-fit connection of the cone area to the accessory and also the screwed connection between the union nut and a thread of the accessory advantageously come to lie in the mixing area of the discharge device. The discharge device, or the length of the transfer channels for the mixture and therefore the dwell time of the mixture in the channels, is not lengthened by the fastening area for an accessory. Moreover, by virtue of the fastening means provided according to the invention for the discharge device, it is possible to use standard accessories that are well known from the prior art.

### BRIEF DESCRIPTION OF THE DRAWINGS

Preferred embodiments of the invention are shown in the drawing, which is not to be interpreted as in any way limiting the invention. Features that become evident from the figures of the drawing are to be understood as belonging to the disclosure of the invention. In the drawing:

FIG. 1 shows an exploded view of a discharge device according to the present invention,

FIG. 2 shows a discharge device according to FIG. 1 in the assembled state,

FIG. 3 shows a longitudinal section through a discharge device according to FIG. 2, and

FIG. 4 shows a longitudinal section through a discharge device with accessory.

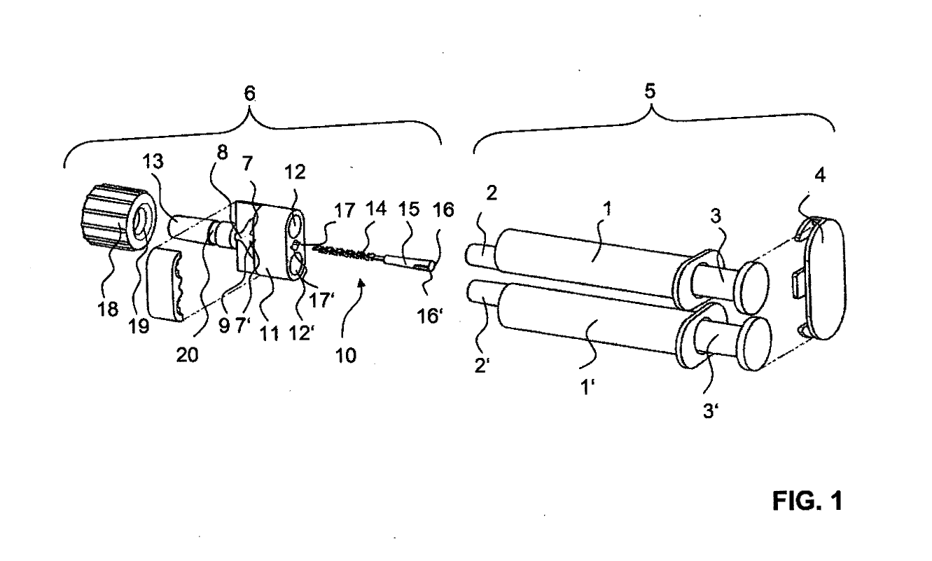

A discharge device according to one embodiment of the present invention is shown in an exploded view in FIG. 1. The discharge device has two syringes, each of them with a container 1, 1′ for receiving a respective mixing component, and each with an outlet 2, 2′ at one end of the containers and with a drive rod 3, 3′ in the form of a ram at the other end of the container. The drive rod seals the containers in a leaktight manner with a plunger that is movable in the longitudinal direction of the containers. A connection element 4 is provided which connects the heads of the drive rods 3 and 3′, such that the drive rods 3 and 3′ and the connection element 4 form a unit. The connection element 4 has slits into which the heads of the drive rods can be inserted with an exact fit.

The container outlets 2, 2′ protrude like tubes from the containers 1, 1′, in the longitudinal direction of the containers. The outlets 2 and 2′ do not have to be arranged centrally. The tube-like continuation can be formed cylindrically on the outer circumference but is preferably made slightly conical.

The unit made up of the two syringes, which are connected to each other via their drive rods 3, 3′ by the connection element 4, forms a kind of double syringe 5. In principle, it is also possible to use double syringes in which the individual containers are provided in a common housing.

FIG. 1 also shows a connector 6, which comprises two inlet channels 7 and 7′, a mixing channel 8, and a channel 9 for insertion of a mixing device 10 into the connector. The channels 7, 7′, 8 and 9 are accommodated in a housing 11 of the connector. The housing 11 and the cone element 13 form a unit. For the discharge device according to the present embodiment, the connector is designed for attachment of two containers holding mixing components. However, it is also possible to further provide a third or fourth inlet channel or even more inlet channels on the housing. The housing 11 according to the present embodiment is elongate and has two adjacent openings 12 and 12′, which are provided for receiving the container outlets 2 and 2′. The receiving openings 12 and 12′ continue like tubes into the interior of the housing 11 and are arranged parallel to each other. The inlet channels 7 and 7′ begin at that end of the receiving openings 12 and 12′ that lies inside the housing. The receiving openings 12 and 12′ can be designed cylindrically, but they are preferably provided with the same conical taper as the outlets 2 and 2′ of the double syringe 5. The outlets 2 and 2′ are pushed into the receiving openings 12 and 12′, such that a fluid connection is formed between the outlets 2 and 2′ of the double syringe and the inlet channels 7 and 7′ of the connector 6. The outlets 2 and 2′ form a snug fit or clamping fit with the receiving openings 12 and 12′, such that the connector 6 is held securely on the double syringe 5. Instead of a snug fit, other types of connections are also possible in principle. For example, an elastic snap-fit connection can be provided, or a lock that is actively operated by hand.

At the opposite end from the receiving openings 12 and 12′, the housing 11 of the connector 6 is adjoined by a cone element 13. The mixing channel 8 opens from the housing 11 into the cone element 13 and extends through the cone element 13 until it emerges at the end of the cone element opposite from the housing 11. In the embodiment shown, the mixing channel 8 extends for the most part inside the cone element 13. This is advantageous, since in this way the length of the cone element 13 can be used, on the one hand, to mix the mixing components and, on the other hand, to fasten an accessory for the discharge device, as will be described below. However, it is also possible in principle for the mixing channel 8 also to be provided partially in the housing 11 or in a cylindrical tube area.

The channel 9 for insertion of the mixing device 10 into the housing 11 extends between the receiving openings 12 and 12′ and substantially parallel to the openings 12 and 12′ and the inlet channels 7 and 7′. The channel 9 merges in its continuation into the mixing channel 8, such that the mixing channel 8 and the channel 9 substantially form a rectilinear passage through the connector 6. The mixing device 10 can thus be inserted into the channel 9 from that end of the housing 11 facing the double syringe 5, such that, in the inserted state, it reaches into the mixing channel 8.

The mixing device 10 is pin-shaped and, at the end that comes to lie in the mixing channel 8, has a mixing helix 14. At the opposite end, a rod-like continuation is provided as centering cylinder 15 which, on opposite sides of the circumference thereof, has securing and positioning wings 16 and 16′. The centering cylinder 15 can have a cylindrical shape but, in the example shown, it is slightly conical. The mixing device 10 has a separating wall 22 between the mixing helix 14 and the centering cylinder 15. When the mixing device is inserted into the mixing channel 8 and the channel 9, the separating wall comes to lie in the mouth area of the two inlet channels 7 and 7′, where the two channels 7, 7′ open into each other and form the start of the mixing channel 8.

At the end where the mixing device 10 is inserted, the channel 9 in the housing 11 has securing and positioning grooves 17 and 17′, which extend in the longitudinal direction of the channel. When the mixing device 10 is inserted with the end of the mixing helix 14 into the channel 9, it is pushed forward through the channel 9 until the mixing helix 14 comes to lie in the area of the cone element 13 in the mixing channel 8, the centering cylinder 15 comes to lie inside the channel 9 in the housing 11, and the separating wall 22 comes to lie in the mouth area of the inlet channels 7, 7′. The centering cylinder 15 closes the channel 9, such that the mixing components fed through the inlet channels 7 and 7′ cannot flow into the channel 9. When the mixing device 10 is pushed fully into the housing, the securing and positioning wings 16 and 16′ of the centering cylinder 15 engage in the securing and positioning grooves 17 and 17′ of the housing. The wings and the grooves serve, on the one hand, as an anti-twist mechanism, such that the mixing device 10 is not able to turn inside the housing 11 or the cone element 13. The connector 6 thus forms a static mixer during the mixing-together of the mixing components with the discharge device according to the invention. On the other hand, the wings and the grooves serve to position or center the mixing device 10 in a predetermined angular orientation in the housing of the connector. The position of the wings and grooves is adopted such that the two components from the inlet channels 7, 7′ are separated from each other by the separating wall 22 until the start of the mixing helix 14. The components from the containers thus remain separate from each other until the mixing process is begun by the mixing helix 14. In this way, it is possible to avoid slow mixing at the start of the mixing channel, where there is no mixing profile.

In principle, mixing devices with different mixing elements can be arranged inside the housing with the cone element. The mixing elements can differ, for example, in terms of their mixing profiles, that is to say it is possible to use a mixing baffle or other mixing profiles instead of the mixing helix 14.

A union nut 18 is also provided on the connector 6. The union nut is designed like a tube and has gripping grooves on its outer circumference, allowing the nut to be gripped, and on its inner circumference it has an internal thread. At the end directed toward the housing 11, the union nut 18 has an inwardly protruding annular collar 19.

An annular groove 20 is provided around the periphery of the cone element 13 near the housing 11. The union nut 18 is fitted over the cone element 13 such that the annular collar 19 comes to lie inside the annular groove 20, with the result that the union nut 18 is secured with respect to a movement in the longitudinal direction of the cone element 13. The union nut 18 is mounted rotatably in the annular groove 20.

In the embodiment shown, the cone element 13 and the union nut 18 form a Luer lock connection. On this Luer lock connection it is possible to fit various accessories of the discharge device, e.g. a discharge nozzle or an injection needle, which likewise use the Luer lock mechanism. In another embodiment of a discharge device according to the invention, no union nut is needed, and instead the cone element 13 has such a taper that a Luer connection is formed. Once again, accessories of the discharge device that have a corresponding female Luer connection can be mounted on this Luer connection. The accessory is then fastened by means of a force fit between the cone element and the accessory on the cone element or the connector. A type of clamping fit or snug fit is thus formed.

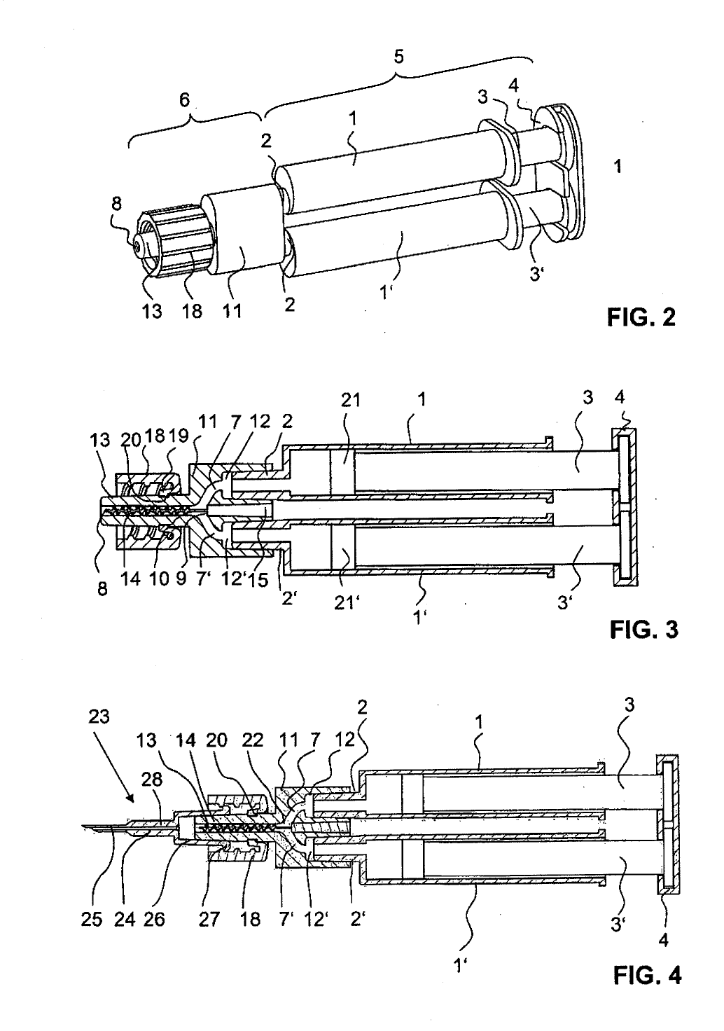

FIG. 2 shows the discharge device from FIG. 1 in the assembled state. The connection element 4 is fitted onto the drive rods 3 and 3′ and connects these to each other. The outlets 2 and 2′ of the containers 1 and 1′ are pushed into the connection openings on the housing of the connector 6. The union nut 18 is arranged over the cone element 13. An accessory of the discharge device can now be fitted onto the Luer lock connection formed by the cone element 13 and the union nut 18, such that the discharge device is ready for use.

FIG. 3 shows a longitudinal section through a discharge device according to FIG. 2. The drive rods 3 and 3′ are received in the containers 1 and 1′, and those ends of the drive rods 3 and 3′ lying in the containers are provided with plungers 21 and 21′, which form a leaktight seal with the inner wall of the containers 1 and 1′ but are movable inside the containers. The connection element 4 is arranged at the opposite ends of the drive rods 3 and 3′ and connects these ends to each other. The outlets 2 and 2′ of the containers 1 and 1′ are pushed into the connection openings 12 and 12′ in the housing 11 of the connector. The tubular outlets 2 and 2′ form a clamping fit with the openings 12 and 12′ in the housing 11, such that the connector 6 sits firmly over the outlets 2 and 2′.

The mixing device 10 is arranged inside the mixing channel 8 and the channel 9. The mixing helix 14 thus comes to lie inside the mixing channel in the interior of the cone element 13, and the extension 15 fills the channel 9.

In the assembled state, there is therefore a fluid connection that starts in the interior of the containers 1 and 1′, extends through the outlets 2 and 2′ into the inlet channels 7 and 7′ and through the mixing channel 8 and emerges from the discharge device, if appropriate through an attached accessory.

The union nut 18 is arranged over the cone element 13, with the annular collar 19 engaging in the annular groove 20 of the cone element 13. As has already been described, an accessory of the discharge device can now be fastened over the cone 13.

FIG. 4 shows the discharge device with a fitted accessory 23. The accessory 23 has a needle holder 24 and a needle 25. The needle holder 24 comprises a cylinder part 26 with an opening that can be pushed over the cone element 13 of the connector 6. On the outer circumference, the cylinder part 26 has an external thread area 27, which meshes in the internal thread of the union nut 18. When the union nut 18 is turned, the cylinder part 26, and thus the accessory 23, is drawn onto the cone element 13 and held securely. From the interior of the cylinder part 26, a discharge channel 28 leads through the needle holder 24 and the needle 25. As can be seen from FIG. 4, the fastening area, in which the accessory 23 is fastened on the cone element 13, comes to lie in the radial direction of the cone element over the mixing area with the mixing helix 14, as is provided according to the invention.

When the drive rods 3 and 3′ are pressed inward by pressure applied to the connection element 4, the mixing components from the containers 1 and 1′ are transferred through the respective outlets 2 and 2′ into the adjoining inlet channels 7 and 7′. The two mixing components are brought together in the mixing channel 8 and, with the pressure still being applied to the connection element 4, are pressed along the mixing helix 14, wherein thorough mixing is achieved by virtue of the mixing helix, and the two mixing components are mixed together to form a mixture. At the end of the mixing channel 8, the mixture passes into the discharge channel 28 of the accessory 23 and, through the latter, out of the discharge device.

It is advantageous that the paths along which the mixing components have to travel inside the discharge device are kept short. Especially in the case of small volumes of mixing components or of a mixture, short paths are important for reducing the loss of the mixture along the paths. It is therefore advantageous that the length of the cone element 13 can be used both to produce the mixture and also to fasten accessories.

### LIST OF REFERENCE SIGNS

1, 1′ container
2, 2′ outlet
3, 3′ drive rod/ram
4 ram connection element
5 double syringe
6 connector
7, 7′ inlet channel
8 mixing channel
9 insertion channel
10 mixing device
11 housing
12, 12′ receiving opening
13 cone element
14 mixing helix
15 centering aid
16, 16′ securing and positioning wings
17, 17′ securing and positioning grooves
18 union nut
19 annular collar
20 annular groove
21, 21′ plunger
22 separating wall
23 accessory
24 needle holder
25 needle
26 cylinder part
27 external thread area
28 discharge channel

1. A discharge device for discharging a mixture, comprising
a connector with at least a first and a second inlet channel, and with a mixing channel into which the inlet channels open and which ends at an outlet;
and a static mixing device with a mixing element, which mixing element is arranged in the mixing channel,
wherein the connector has a cone area, which is designed as a fastening area for an accessory and of which the outer circumference tapers continuously in a conical formation along a longitudinal direction as far as the outlet of the mixing channel and which radially surrounds a distal end portion of the mixing channel ending at the outlet,
wherein the cone area is designed as a male Luer cone with a taper of approximately 6% with respect to the longitudinal direction, and
wherein at least part of the mixing element of the mixing device is arranged in the distal end portion of the mixing channel surrounded by the cone area.

2. The discharge device as claimed in claim 1, wherein the mixing element extends along at least 90% of the length of the distal end portion of the mixing channel surrounded by the cone area in this distal end portion.

3. The discharge device as claimed in claim 1, wherein the mixing element extends substantially along the entire length of the distal end portion of the mixing channel surrounded by the cone area and substantially as far as the outlet of the mixing channel.

4. The discharge device as claimed in claim 1, wherein the cone area has a length of at least 7 mm, a minimum diameter of 3.92-4.027 mm and a maximum diameter of 4.270-4.315 mm.

5. The discharge device as claimed in claim 1, additionally comprising:
at least two containers, each receiving a mixing component, wherein each of the containers has a container outlet,
a discharge mechanism for discharging the mixing components through the container outlets,
wherein the connector adjoins the container outlets.

6. The discharge device as claimed in claim 5, wherein the connector is removable from the container outlets.

7. The discharge device as claimed in claim 5, wherein the connector is integrally connected to the container outlets.

8. The discharge device as claimed in claim 1, wherein the connector has an insertion channel which, in a proximal direction facing away from the distal end area, adjoins the mixing channel along the longitudinal direction, and which opens out from the connector in the proximal direction, wherein the mixing element is adapted to be inserted through the insertion channel into the mixing channel.

9. The discharge device as claimed in claim 8, wherein the insertion channel is arranged between the inlet channels.

10. The discharge device as claimed in claim 8, wherein the insertion channel has an anti-twist mechanism for the mixing device.

11. The discharge device as claimed in claim 8, wherein the insertion channel has a positioning mechanism for the mixing device.

12. The discharge device as claimed in claim 1, wherein the cone element has an annular groove on the outer circumference, in which annular groove a union nut with an internal thread is held.

13. The discharge device as claimed in claim 12, wherein the cone element with the union nut is designed as a Luer lock connection.

14. The discharge device as claimed in claim 1, with an accessory mounted on the cone area.
